(19) United States
(12) Patent Application Publication
(10) Pub. No.: US 2004/0157582 A1
(43) Pub. Date: Aug. 12, 2004

(54) Device and method for temporary deactivation of subscriber information

(76) Inventors: Marc Peglion, Tampere (FI); Esko Paldan, Lempaala (FI); Olavi Kari Virtanen, Tampere (FI); Timo Eskelinen, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/477,394

(22) PCT Filed: May 17, 2001
(86) PCT No.: PCT/EP01/05678

(51) Int. Cl. H04Q 7/20

(52) U.S. Cl. 455/403

(57) ABSTRACT

The invention relates to a method and system for controlling information flow in a communication system comprising at least one subscriber equipment, and a subscriber information database entity which contains subscription-related information for defining the management of packet-based information flow to and/or from respective subscriber equipments. The database entity contains additional information associated to the stored subscription-related information which additional information defines whether stored subscription-related information may or may not be used for actually defining the management of packet-based information flow to and/or from respective subscriber equipments.

### FIELD AND BACKGROUND OF THE INVENTION

The invention relates to the management of subscriber information in a communication network, preferably a packet-based network such as a GPRS system. The subscriber information to be managed is contained in a database, preferably a subscriber information register such as HLR (Home Location Register).

More specifically, the invention relates to the management of PDP context information of one or more subscribers contained in a subscriber information register such as HLR.

Whenever an operator wants to bar a certain PDP context of a subscriber from the GPRS network, without barring the entire subscriber, it usually has to delete that PDP context entirely from the HLR database. When subsequently unbarring that PDP context for the subscriber, the operator must then newly re-create this PDP context. This procedure is difficult and sometimes not reliable as the operator has to ensure that the data of the “new” PDP context is the same as it was before deletion. Such operations are likely to happen when e.g. a subscriber has one or a certain number of prepaid PDP contexts which the operator wants to de-activate temporarily while the accounts are zero, while being allowed to re-activate them when the accounts are refilled by the subscriber.

Another situation may be a case when an operator may want to mass-produce subscriber information for a plurality of GPRS subscribers, but not give the subscribers immediate access to the network. This permits the operator to have standard PDP contexts available for each and every subscriber in the HLR, but to activate these contexts only when the subscriber(s) actually subscribe(s) to a GPRS connection.

### SUMMARY OF THE INVENTION

The invention provides a system and method for temporary deactivation of subscriber information in a register, preferably for temporary deactivation of one or more PDP context(s) provided for one or more subscriber(s).

The present invention provides a system, method and/or database entity as defined in the independent claims or any of the dependent claims.

In accordance with one aspect of the invention, a method and system are provided for controlling information flow in a communication system comprising at least one subscriber equipment and a subscriber information database entity which contains subscription-related information for defining the management of packet-based information flow, preferably GPRS traffic, to and/or from respective subscriber equipments. The database entity contains additional information associated to the stored subscription-related information which additional information defines whether stored subscription-related information may or may not be used for actually defining the management of packet-based information flow to and/or from respective subscriber equipments.

The communication system preferably comprises at least one support node, in particular a GPRS Support Node such as a SGSN, for handling the information flow to and/or from the subscriber equipment. The subscriber information database entity preferably is a Home Location Register (HLR).

The subscription-related information may correspond to at least one PDP Context for one or more of the subscribers.

When additional information defining that the stored subscription-related information may not be used for actually defining the management of packet-based information flow to and/or from respective subscriber equipments is written into the database entity, the database entity preferably sends a message to the support node storing the subscription-related information, the message commanding the support node to delete the stored subscription-related information. When additional information defining that the stored subscription-related information may be used for actually defining the management of packet-based information flow to and/or from respective subscriber equipments is written into said database entity, the database entity sends a message to the support node for copying at least part of the subscription-related information stored in the database entity to the support node for subsequent use for defining the management of packet-based information flow to and/or from respective subscriber equipments.

The additional information may be written into the database from an operator entity.

The invention permits a network operator or other person/authority/entity to disable a subscriber's PDP context without actually deleting it from the subscriber register, e.g. HLR containing or forming the database entity. This means that should the operator want to re-enable the PDP context, there is no need to re-create the entry in the subscriber data in the subscriber register. The operator just needs to “activate” the PDP context.

This solution provides a viable improvement on e.g. PDP context handling in subscriber's GPRS data. It saves much time and the subscription is guaranteed to remain unchanged when temporarily barring it from the network as the PDP context data is not removed from the HLR but just “deactivated”.

It is therefore easy for the operator to ensure that the data in the “new” PDP context is the same as it was before deletion. Such a temporary deactivation of PDP contexts may e.g. be performed by an operator when a subscriber has one or a certain number of prepaid PDP contexts which the operator wants to de-activate temporarily while the prepaid accounts are empty, while being allowed to re-activate them when the account(s) are refilled by the subscriber.

The invention furthermore e.g. allows an operator to mass-produce information for subscribers, e.g. GPRS subscribers, but not give them immediate access to the network. This permits the operator to have standard PDP contexts available for each and every subscriber in the subscriber register, e.g. HLR, but to activate them only when the subscriber actually subscribes to a GPRS connection.

According to a preferred implementation of the invention, a Functional status flag is added to the PDP context data in the subscriber database (subscriber information database entity). This flag represents the additional information mentioned above and will be read by the database to define whether or not the PDP context data should be made available to the subscriber's current SGSN.

The invention provides HLR support in a GPRS network. Since the additional information, e.g. Functional Status flag, is not transmitted to the outside of the HLR, there is no adverse affect on the standards such as ETSI/3GPP standards. Thus the invention is completely independent of the present standards.

The invention does not affect the external interfaces of the subscriber database such as HLR and is an improvement on the inner workings of the database.

The invention is easy to implement and provides remarkable advantages, e.g. in situations where there is a malfunction or a problem in the behaviour of the network or a subscriber.

The invention enables prompt reduction of usage of PDP contexts without deleting the whole PDP context(s).

The invention does not affect HLR capacity to handle traffic to SGSN and the signalling between HLR and SGSN remains the same.

In accordance with one of the preferred optional aspects of the invention, after a predetermined time since deactivation, a deactivated PDP context can be removed from HLR.

### BRIEF DESCRIPTION OF THE DRAWINGS

FIG. 1 illustrates a basic structure of a communication system in accordance with an embodiment of the invention, and

FIG. 2 shows the structure of a table contained in a subscriber information register.

### DETAILED DESCRIPTION OF PREFERRED EMBODIMENTS OF THE INVENTION

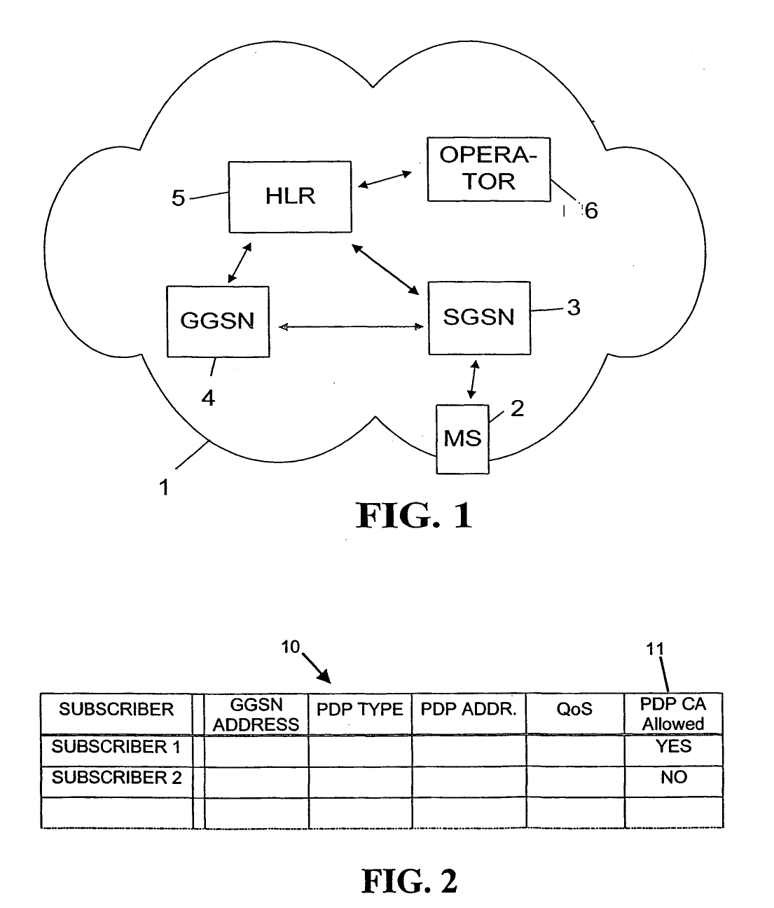

FIG. 1 shows the system architecture of a communication system (or network) 1, e.g. of GPRS (General Packet Radio service) or GSM structure such as public land mobile network (PLMN). A mobile or fixed user terminal 2, e.g. GSM mobile station, is denoted as MS.

One or more subscriber information registers such as home location register (HLR) 5 include(s) data bases available for call control and network management. For all users registered with a network operator, permanent data (such as the user's profile) as well as temporary data (such as the user's current location) are stored in the HLR 5. In case of a call to a user, the HLR 5 is always first queried, to determine the user's current location.

In order to integrate GPRS into the existing GSM architecture, a GPRS System Architecture comprising a class of network nodes, called GPRS support nodes (GSN) 3, 4, has been introduced. GSNs are responsible for the delivery and routing of data packets between the mobile stations and other terminals or networks such as external packet data networks (PDN).

A Serving GPRS Support Node (SGSN) is responsible for the delivery of data packets from and to the mobile stations 2 within its service area. Its tasks include packet routing and transfer, mobility management (attach/detach and location management), logical link management, and authentication and charging functions. The location register of the SGSN 3 stores location information (e.g., current cell, current VLR) and user profiles (e.g., IMSI, address(es) used in the packet data network) of all GPRS users registered with this SGSN 3.

A Gateway GPRS Support Node (GGSN) 4 acts as an interface between the GPRS backbone network and external packet data networks. It converts the GPRS packets coming from the SGSN into the appropriate packet data protocol (PDP) format (e.g., IP or X.25) and sends them out on the corresponding packet data network. In the other direction, PDP addresses of incoming data packets are converted to the GSM address of the destination user. The readdressed packets are sent to the responsible SGSN. For this purpose, the GGSN stores the current SGSN address of the user and his or her profile in its location register.

Via appropriate interfaces, user data and signaling data are transmitted between the GSNs. All GSNs are connected via an IP-based GPRS backbone network.

Interfaces may connect the network 1 with external public or private PDNs, such as the Internet or corporate intranets.

The HLR 5 serves as subscriber information database entity and stores the subscription-related information such as user profile, the current SGSN address, and the PDP address(es) for each GPRS user in the network 1. An interface is used to exchange this information between HLR 5 and SGSN 3. For example, the SGSN 3 informs the HLR 5 about the current location of the MS. When the MS 2 registers with a new SGSN, the HLR 5 will send the user profile to the new SGSN. The signaling path between GGSN 4 and HLR 5 may be used by the GGSN 4 to query a user's location and profile in order to update its location register.

The invention allows the operator or any other authorized person or entity to declare and set a subscriber's PDP context data stored in HLR 5 “Inactive”, in other words to “De-activate” a subscriber's PDP context stored in HLR 5. “De-activate” is to be understood to forbid this PDP context or PDP context related information or PDP context information to be sent to the subscriber's current GSN, e.g. SGSN 3.

FIG. 2 schematically shows part of the data stored in the register 5. The register 5 includes a database 10 which contains PDP Context data for each, or at least some of the registered subscribers. In the table shown in FIG. 2, the data are schematically inserted in rows for the respective subscribers “Subscriber 1”, “Subscriber 2”, etc. This is of course an example only. The arrangement of subscribers and associated data in the table or database may be arbitrary, provided that the interrelation between subscribers and associated data is clear.

The PDP Context data of database 10 include the customary information such as the address of a GGSN to be used for a subscriber in case of GGSN necessity, PDP type such as IPv4, PDP address, QoS (Quality of Service) etc. In accordance with the present invention, the database contains additional information such as the flags (PDP Context Activation (CA) Allowed) shown in column 11. This additional information indicates whether or not the PDP Context information stored for a respective subscriber may be used for a requested PDP Context Activation.

In a further embodiment, several PDP Contexts may be stored for one subscriber each. Each stored PDP Context may have a separate flag indicating whether or not the respective PDP Context can be used. This allows to selectively offer all, only a restricted number, or none of all the PDP Contexts provided for a subscriber in case a PDP Context Activation is requested for this subscriber.

When a PDP context is de-activated, the HLR 5 will send a message, e.g. DSD, to the relevant SGSN 3 to remove the PDP context from the subscriber data stored there, while keeping the data stored in the HLR database for further use. DSD (Delete Subscriber Data) is a MAP operation where the HLR can delete/remove part of a subscriber's data, like a PDP context, from the SGSN's database. This operation is not used to remove the entire subscription. It is important to note that the stored PDP context data is not removed from the HLR in this operation.

When the PDP context is re-activated, the HLR 5 sends a message, e.g. ISD, to the SGSN, using the existing HLR data, to restore the PDP context's connection to the GPRS network. ISD (Insert Subscriber Data) is a MAP operation with which the HLR can add a subscriber to the SGSN database, and also Add/Modify a subscriber's data within that database.

Another feature of this invention is that the operator 6 may assign “inactive” PDP contexts to its subscribers, hence making them “GPRS ready”, but may inhibit the activation of the PDP contexts until the subscriber actually subscribes for a GPRS connection.

The invention is preferably implemented by adding the flag information shown in column 11 of FIG. 2, e.g. a Functional Status flag, to the PDP context data in the HLR 5. This flag is not transmitted to the outside of the HLR 5 and thus does not affect the standards, e.g. ETSI/3GPP standards. The flag can be set to “Active” or “De-Activated” by an operator (equipment) 6 sending appropriate messages to the HLR 5. The flag will be read by the HLR 5 to define whether or not the PDP context data should be made available to the subscriber's current GSN, e.g. SGSN 3.

When a PDP context is de-activated, the HLR 5 will send a message, e.g. DSD, to the relevant SGSN 3 to remove the PDP context from the subscriber data stored there, while keeping the data stored in the HLR database for further use. When the PDP context is to be re-activated, the HLR 5 sends a message, e.g. an ISD, to the SGSN 3, using the existing HLR data, to restore the PDP context's connection to the GPRS network. The data is not removed from the HLR in this operation.

In accordance with another embodiment of the invention, a timer means is provided in the subscriber information database entity, such as the HLR, or in an entity cooperating with the database entity. A time measurement is started by triggering the timer means when a deactivation of a PDP Context takes place. The subscriber information database entity, or the entity cooperating with the database entity, are adapted to automatically completely delete a deactivated PDP Context after a predetermined time (e.g. a week or several days) since deactivation. The deactivated PDP context will thus be completely removed from the database entity. This ensures an automatic cancellation of inactivated PDP Contexts, avoiding the problem of too large memory capacity being occupied by inactivated PDP Contexts.

Although the invention has been described above with reference to specific embodiments, the scope of the invention also covers any alterations, additions, modifications, and omissions of the disclosed features.

1. Method for controlling information flow in a communication system comprising at least one subscriber equipment and a subscriber information database entity which contains subscription-related information for defining the management of packet-based information flow to and/or from respective subscriber equipments, wherein the database entity contains additional information associated to the stored subscription-related information, said additional information defining whether stored subscription-related information may or may not be used for actually defining the management of packet-based information flow to and/or from respective subscriber equipments.

2. Method according to claim 1, wherein the communication system comprises at least one support node for handling the information flow to and/or from the subscriber equipment.

3. Method according to claim 2, wherein the support node is a GPRS Support Node.

4. Method according to any one of the preceding claims, wherein the subscriber information database entity is a Home Location Register (HLR).

5. Method according to any one of the preceding claims, wherein the subscription-related information concerns one or more PDP Contexts.

6. Method according to any one of the preceding claims, wherein, when said additional information defining that the stored subscription-related information may not be used for actually defining the management of packet-based information flow to and/or from respective subscriber equipments is written into said database entity, the database entity sends a message to a support node storing the subscription-related information, the message commanding the support node to delete the stored subscription-related information.

7. Method according to any one of the preceding claims, wherein, when said additional information defining that the stored subscription-related information may be used for actually defining the management of packet-based information flow to and/or from respective subscriber equipments is written into said database entity, the database entity sends a message to a support node for copying at least part of the subscription-related information stored in the database entity to the support node for subsequent use for defining the management of packet-based information flow to and/or from respective subscriber equipments.

8. Method according to any one of the preceding claims, wherein said additional information defining that the stored subscription-related information may or may not be used for actually defining the management of packet-based information flow to and/or from respective subscriber equipments is written into said database from an operator entity.

9. Method according to any one of the preceding claims, wherein said packet-based information flow is based on GPRS.

10. Method according to any one of the preceding claims, wherein stored subscription-related information which is defined by the associated additional information not to be used for actually defining the management of packet-based information flow to and/or from respective subscriber equipments, is automatically deleted from the database entity after expiry of a predetermined time interval after writing this additional information into the database entity.

11. System for controlling information flow in a communication system comprising at least one subscriber equipment and a subscriber information database entity which contains subscription-related information for defining the management of packet-based information flow to and/or from respective subscriber equipments, wherein the database entity contains additional information associated to the stored subscription-related information, said additional information defining whether stored subscription-related information may or may not be used for actually defining the management of packet-based information flow to and/or from respective subscriber equipments.

12. System according to claim 11, comprising at least one support node for handling the information flow to and/or from the subscriber equipment.

13. System according to claim 12, wherein the support node is a GPRS Support Node.

14. System according to any one of the preceding system claims, wherein the subscriber information database entity is a Home Location Register (HLR).

15. System according to any one of the preceding system claims, wherein the subscription-related information is or concerns one or more PDP Contexts.

16. System according to any one of the preceding system claims, wherein, when said additional information defining that the stored subscription-related information may not be used for actually defining the management of packet-based information flow to and/or from respective subscriber equipments is written into said database entity, the database entity sends a message to a support node storing the subscription-related information, the message commanding the support node to delete the stored subscription-related information.

17. System according to any one of the preceding system claims, wherein, when said additional information defining that the stored subscription-related information may be used for actually defining the management of packet-based information flow to and/or from respective subscriber equipments is written into said database entity, the database entity sends a message to a support node for copying at least part of the subscription-related information stored in the database entity to the support node for subsequent use for defining the management of packet-based information flow to and/or from respective subscriber equipments.

18. System according to any one of the preceding system claims, comprising an operator entity for writing said additional information into said database.

19. System according to any one of the preceding system claims, wherein said packet-based information flow is based on GPRS.

20. System according to any one of the preceding system claims, wherein a timer means is provided in the subscriber information database entity or in an entity cooperating with the database entity, the database entity or cooperating entity being adapted to trigger the timer means when a deactivation of stored subscription-related information takes place, and to delete, after expiry of a predetermined time after deactivation, a deactivated stored subscription-related information from the database entity.

21. Subscriber information database entity, preferably for use in a method according to any one of the preceding method claims, or in a system according to any one of the preceding system claims, said database entity containing subscription-related information for defining the management of packet-based information flow to and/or from subscriber equipments, as well as additional information associated to the stored subscription-related information, said additional information defining whether stored subscription-related information may or may not be used for actually defining the management of packet-based information flow to and/or from respective subscriber equipments.

22. Database entity according to claim 21, wherein the subscriber information database entity is a Home Location Register (HLR).

23. Database entity according to claim 21 or 22, wherein the subscription-related information is or concerns one or more PDP Contexts.

24. Database entity according to any one of the preceding entity claims, wherein, when said additional information defining that the stored subscription-related information may not be used for actually defining the management of packet-based information flow to and/or from respective subscriber equipments is written into said database entity, the database entity is adapted to send a message to a support node storing the subscription-related information, the message commanding the support node to delete the stored subscription-related information.

25. Database entity according to any one of the preceding entity claims, wherein, when said additional information defining that the stored subscription-related information may be used for actually defining the management of packet-based information flow to and/or from respective subscriber equipments is written into said database entity, the database entity is adapted to send a message to a support node for copying at least part of the subscription-related information stored in the database entity to the support node for subsequent use for defining the management of packet-based information flow to and/or from respective subscriber equipments.

26. Database entity according to any one of the preceding entity claims, comprising a timer means, the database entity being adapted to trigger the timer means when a deactivation of stored subscription-related information takes place, and to delete, after expiry of the timer means, a deactivated stored subscription-related information from the database entity.
